(19) United States
(12) Patent Application Publication
(10) Pub. No.: US 2007/0098156 A1
(43) Pub. Date: May 3, 2007

(54) Digital rights management

(76) Inventor: Philip Blythe, Victoria (AU)

Correspondence Address: LADAS & PARRY, 5670 WILSHIRE BOULEVARD, SUITE 2100, LOS ANGELES, CA, 90036-5679, US

(21) Appl. No.: 10/559,942

(22) PCT Filed: Mar. 1, 2005
(86) PCT No.: PCT/AU05/00287

§ 371 Date: Sep. 18, 2006

Related U.S. Application Data
(60) Provisional application No. 60/553,366, filed on Mar. 16, 2004.

(30) Foreign Application Priority Data
Mar. 16, 2004 (AU) 2004901382

(51) Int. Cl. H04K 1/06; G06Q 99/00; H04K 1/04; H04L 9/00; H04K 1/00

(52) U.S. Cl. 380/37; 705/59

(57) ABSTRACT

A method for allocating to a device a license to use digital content, the method comprising the steps of: receiving a first block of ciphertext from the device; decrypting the first block of ciphertext to obtain a second block of ciphertext; determining whether the second block of ciphertext meets a criterion; and allocating the license to the device if the second block of ciphertext meets the criterion.

### FIELD OF THE INVENTION

The present invention relates generally to the field of digital rights management. More particularly, the present invention relates to a method and system for issuing a license to use digital content, and a method and system for requesting the license.

### BACKGROUND OF THE INVENTION

Digital Rights Management (DRM) is the term which is commonly used to describe a range of techniques that use information about rights and rightsholders to manage copyright material (particularly digital content) and the terms and conditions on which it is made available to users.

The application of DRM to the Internet (or just about any other communication network) typically involves a license server sending a license over the Internet to a device. When processed by the device, the license allows the device to use the associated digital content. The license typically consists of usage rights that define what can and cannot be done with the associated digital content.

It is possible that a third party could easily intercept the license when exchanged over the Internet and thereby allowing the third party to gain unauthorized access to the digital content. Consequently, it may be desirable to have in place techniques that allow the license to be securely exchanged (allocated) over the Internet. Furthermore, it is possible for parties to send the license server a request for the license. Therefore, it may also be desirable to also have in place a mechanism for checking whether a request for a license is valid.

### SUMMARY OF THE INVENTION

According to a first aspect of the present invention, there is provided a method for allocating to a device a license to use digital content, the method comprising the steps of:

receiving a first block of ciphertext from the device;

decrypting the first block of ciphertext to obtain a second block of ciphertext;

determining whether the second block of ciphertext meets a criterion; and

allocating the license to the device if the second block of ciphertext meets the criterion.

Thus, the method according to the first aspect of the present invention provides a significant advantage which results from the step of determining whether the second block of ciphertext meets a criterion. The advantage being that it provides a mechanism for checking whether a request for the license (which would be accompanied by the first block of ciphertext) is a valid request. If the request is valid (that is, the second block of ciphertext meets the criterion) the license will be allocated to the device.

Preferably, the step of allocating the license comprises the steps of:

encrypting the first block of ciphertext to obtain a third block of ciphertext;

obtaining a usage right for the digital content; and

providing the device with the third block of ciphertext and an encrypted version of the usage right.

The previous three steps provide two advantages. The first advantage is that by providing the device with the third block of ciphertext, the method is supplying the device with a block of ciphertext that will ensure that the next request for the license which the device issues will be considered valid; that is, it will enable the device to provide a block of ciphertext that meets the criterion. The second advantage stems from the fact that an encrypted version of the usage right (license) is provided to the device. This minimizes the ability for an unauthorized party to make use of the usage right because it is encrypted.

Preferably, the step of determining whether the second block of ciphertext meets the criterion comprises the step of determining whether the second block of ciphertext corresponds to a last block of ciphertext received in relation to a request for the license.

Preferably, the step of allocating the license comprises the step of updating the last block of ciphertext such that it corresponds to the first block of ciphertext.

Preferably, the method further comprises the steps of:

determining whether there exists a previous block of ciphertext that was received in relation to another request for a license and which corresponds to the second block of ciphertext; and

issuing the device with a notification that the license has expired if it is determined that the previous block of ciphertext exists and was obtained prior to the last block of ciphertext being obtained;

wherein the steps of determining whether there exists a previous block, and issuing the device with the notification are carried out upon determining that the second block of ciphertext does not meet the criterion.

Preferably, the license is arranged to expire after a predetermined period of time.

According to a second aspect of the present invention, there is provided a method of requesting a license to use digital content, the method comprising the steps of:

obtaining a first block of ciphertext from a system arranged to allocate the license;

encrypting the first block of ciphertext to obtain a second block of ciphertext; and

providing the second block of ciphertext to the system when requesting the license.

Preferably, the method further comprises the step of providing the second block of ciphertext to another device for use thereby when requesting the license.

According to a third aspect of the present invention, there is provided a system for allocating a license to use digital content to a device, the system comprising a processing means arranged to perform the steps of:

receiving a first block of ciphertext from the device;

decrypting the first block of ciphertext to obtain a second block of ciphertext;

determining whether the second block of ciphertext meets a criterion; and

allocating the license to the device if the second block of ciphertext meets the criterion.

Preferably, the processing means is arranged to perform the following steps when allocating the license to the device:

encrypting the first block of ciphertext to obtain a third block of ciphertext;

obtaining a usage right for the digital content; and

providing the device with the third block of ciphertext and an encrypted version of the usage right.

Preferably, the processing means is arranged to perform the following step when determining whether the second block of ciphertext meets the criterion: determining whether the second block of ciphertext corresponds to a last block of ciphertext received in relation to a request for the license.

Preferably, the processing means is arranged to perform the step of updating the last block of ciphertext such that it corresponds to the first block of ciphertext when allocating the license.

Preferably, the processing means is arranged to perform the following steps:

determining whether there exists a previous block of ciphertext that was received in relation to another request for a license and which corresponds to the second block of ciphertext; and

issuing the device with a notification that the license has expired if it is determined that the previous block of ciphertext exists and was obtained prior to the last block of ciphertext being obtained;

wherein the steps of determining whether there exists a previous block, and issuing the device with the notification are carried out upon determining that the second block of ciphertext does not meet the criterion.

Preferably, the license is arranged to expire after a predetermined period of time.

According to a fourth aspect of the present invention, there is provided a device for requesting a license to use digital content, the device comprising a processing means arranged to perform the following steps:

obtaining a first block of ciphertext from a system arranged to allocate the license;

encrypting the first block of ciphertext to obtain a second block of ciphertext; and

providing the second block of ciphertext to the system when requesting the license.

Preferably, the processing means is arranged to perform the step of providing the second block of ciphertext to another device for use thereby when requesting the license.

According to a fifth aspect of the present invention, there is provided a computer program comprising at least one instruction for causing a computing device to carry out the method according to the first aspect of the present invention or the method according to the second aspect of the present invention.

According to a sixth aspect of the present invention, there is provided a computer readable medium comprising the computer program according to the fifth aspect of the present invention.

### BRIEF DESCRIPTION OF THE DRAWINGS

Notwithstanding any other embodiments that may fall within the scope of the present invention, an embodiment of the present invention will now be described, by way of example only, with reference to the accompanying figures, in which:

FIG. 1 provides a schematic diagram of a system in accordance with an embodiment of the present invention;

FIG. 2 is a flow chart of various steps performed by the system of FIG. 1; and

FIG. 3 is another flow chart of various steps performed by the system of FIG. 1.

### AN EMBODIMENT OF THE INVENTION

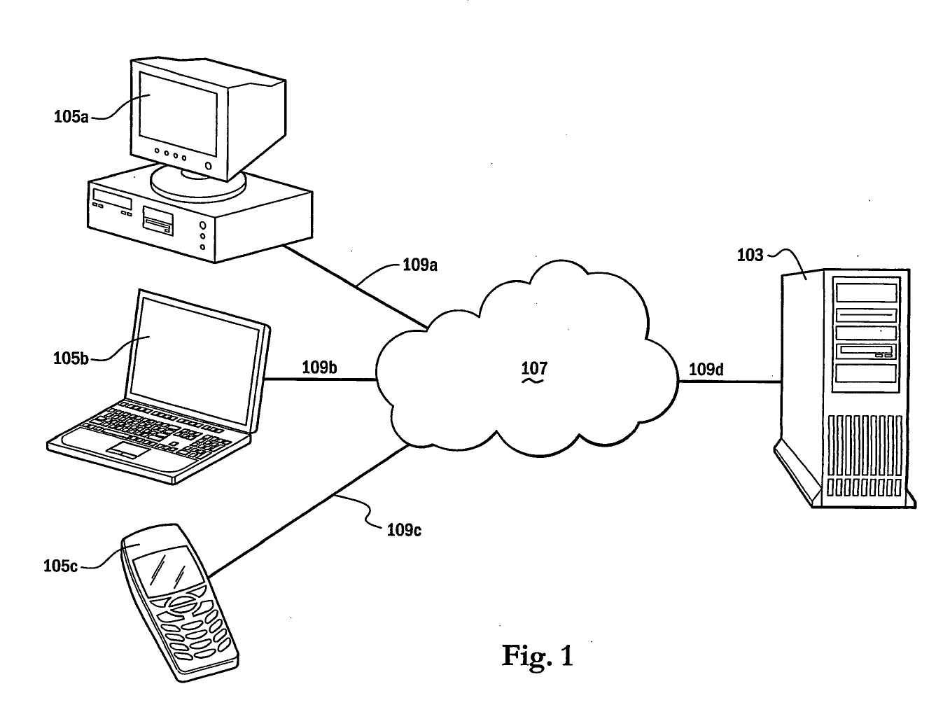

With reference to FIG. 1, which is a schematic diagram of a system 100 embodying the present invention, the system 100 comprises a license server 103 and several computing devices 105. The license server 103 and the computing devices 105 are connected to a communication network 107, which in this embodiment of the present invention is an IP based packet switched network (such as the Internet). As will be readily apparent to persons skilled in the art, the communication network 107 could be based on other networking technology such as a GPRS wireless network.

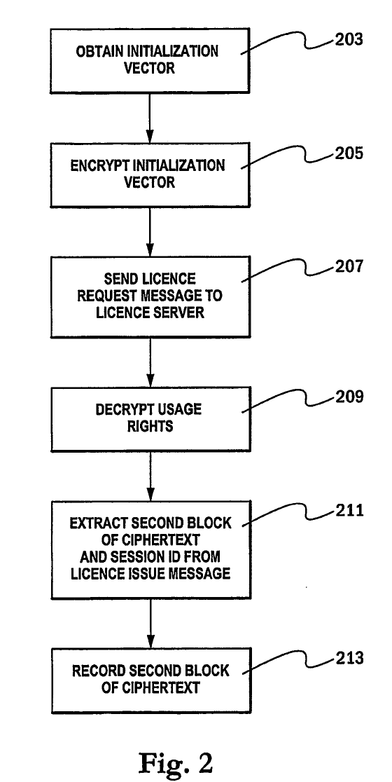

The computing devices 105 are in the form of personal desktop computers; however, it is envisaged that the computing devices 105 could be just about any personal computing device such as a personal digital assist (PDA), a laptop computer or mobile phone. Each computing device 105 comprises traditional hardware such as a motherboard, RAM, hard disk, network interface, video card, power supply, video monitor, keyboard and mouse. The hard disk of each computing device 105 is loaded with operating system software (such as the Microsoft XP operating system), which essentially cooperates with the hardware of the computing device 105 to provide an environment in which software applications can be executed. In this regard, each computing device 105 has installed on its hard disk a media player software application that enables a user of a computing device 105 to play digital content (media) such as a video and/or audio clip. The various functions (or steps) performed by the media player software application are shown in the flow chart 200 in FIG. 2.

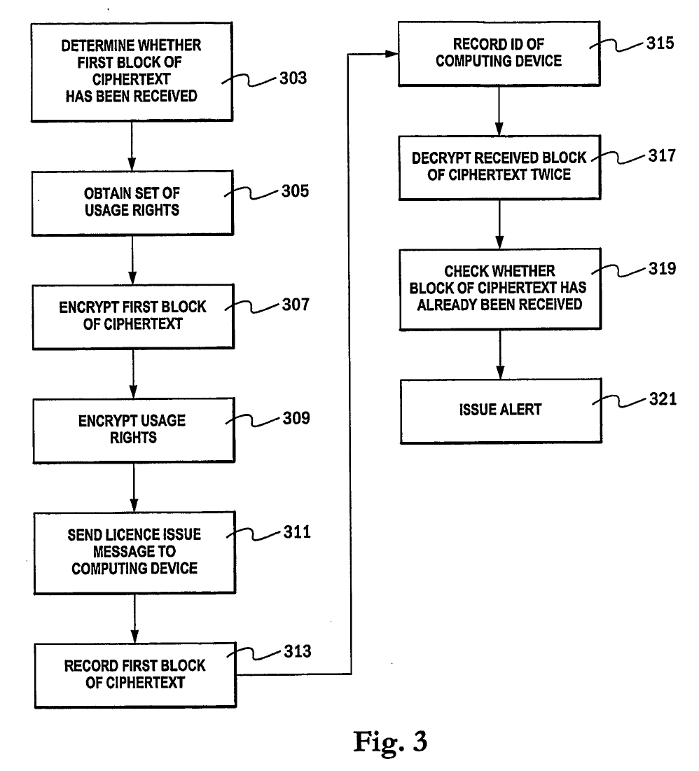

The license server 103 is in the form of a computer configured to operate as a computer server. Like the computing devices 105, the license server 103 comprises hardware such as a motherboard, RAM, a hard disk, network interface, and a power supply. In addition to the hardware the license server 103 comprises operating system software (such as UNIX) that is loaded on the hard disk of the license server 103. The operating system software basically cooperates with the hardware to provide an environment in which software applications can be executed. In this regard, the hard disk of the license server 103 is loaded with a digital rights management software application. The digital rights management software application is essentially responsible for managing digital rights, which the media player software application loaded on each computing device 105 uses to essentially determine whether a user is entitled to play (that is, view or listen to) a particular piece of digital content. The various functions (steps) performed by the digital rights management software application are shown in the flow chart 300 in FIG. 3.

As mentioned previously, the communication network 107 is in the form of an IP based packet switched network. Consequently, the communication network 107 comprises a plurality of interconnected routers (which are not shown in the figures). As person skilled in the art will readily appreciate the routers are basically arranged to route data packets among themselves in order to deliver the data packets from a sender to a recipient.

To exchange data with each other the computing devices 105 and the license server 103 are connected to the communication network 107 via data links 109. Each data link 109 is electrically coupled to a respective network interface of the license server 103 or computing device 105 and to a network access point of the communication network 107.

As discussed previously, in order to play digital content the media player software application installed on the computing device 105 is arranged to obtain a digital right (license) to play the digital content. In this regard, the first step 203 that the media player is arranged to perform is to obtain an Initialization Vector (IV), which is in the form of a cryptographically secure random string of binary data. The Initialization Vector is generated by a secure random number generator that is integrated into the media player software application.

The second step 205 that the media player software application performs is to encrypt the Initialization Vector using a strong encryption algorithm in the form of the Advanced Encryption Standard (AES) with PKCS7. Persons skilled in the art will appreciate that other encryption algorithms such as Triple-DES could be used in other embodiments of the invention. The second step 205 involves using a symmetric encryption key (Ks), which is also known to the license sever 103, that is stored on the hard disk of the computing device 105. The symmetric encryption key (Ks) is actually generated by the license server 103 and distributed to the computing device 105 using the Internet Key Exchange (IKE) protocol. Persons skilled in the art will, however, appreciate that other key exchange techniques could be employed in alternative embodiments of the present invention. Encrypting the Initialization Vector results in a first block of ciphertext; that is an encrypted version of the Initialization Vector.

Subsequent to carrying out the second step 205, the media player software application proceeds to carry out the third step 207 of sending a license request message to the license server 103 via the communication network 107. The license request message is sent in an IP packet, and comprises the first block of ciphertext (which was created during the second step 205), an identifier of the computing device 105 requesting the license, authentication credentials used to validate the initial license request, and a session identifier. In this embodiment of the present invention, the identifier of the computing device 105 is a public cryptographic key of the computing device 105 requesting the license. The public cryptographic key is calculated as a hash of the computing device 105 private cryptographic key using a strong digest algorithm such as SHA 256. It will be appreciated by persons skilled in the art that the identifier of the computing device 105 could be another form of identifier such as the IP address of the computing device 105.

When the license server 103 receives the license request message from the computing device 105, the digital rights management software application loaded on the hard disk of the license server 103 basically processes the license request message to determine whether a license (digital right) to use the digital content should be issued to the computing device 105. The first step 303 carried out by the digital right management software application is to process the license request message to determine whether the license server 103 has previously received the first block of ciphertext from the computing device 105. For an initial request for the license the license server 103 will not have received the first block of ciphertext, and so the digital rights management software application validates the authentication credentials, and if valid, allocates the license to the computing device 105.

The process of allocating the license to the computing device 105 comprises the step 305 of obtaining a set of usage rights (which defines what can and cannot be done with the digital content). Subsequent to performing the step 305 of obtaining the set of usage rights, the digital rights management software application performs the step 307 of encrypting the first block of ciphertext received in the license request to produce a second block of ciphertext. When encrypting the first block of ciphertext the digital rights management software application uses the same encryption Advanced Encryption Standard algorithm and cryptographic key Ks that was previously used by the media player software application loaded on the computing device 105.

Subsequent to performing the previous step 307, the digital rights management software application performs the step 309 of encrypting the usage rights, using the same Advanced Encryption Standard algorithm and cryptographic key Ks that was used in previous steps. Following on from the last step 309, the digital rights management software application performs the step 311 of sending the encrypted usage rights (created during step 309), the second block of ciphertext (created during step 307), and a session identifier in a license issue message to the computing device 105. The license issue message is sent to the computing device 105 via the communication network 107. The license issue message is sent as an IP packet.

When allocating (or sending) the license to the computing device 105, the digital rights management software application on the license server 103 also performs the step 313 of making a record of the first block of ciphertext received from the computing device 105. The record of the first block of ciphertext effectively represents the last block of ciphertext received in relation to a valid request for the license. The digital rights management software application also carries out the step 315 of recording the id of the computing device 105 as the current holder of the license.

When the computing device 105 receives the license issue message from the license server 103 via the communication network 107, the media player software application loaded on the computing device 105 performs the step 209 of decrypting the encrypted usage rights in the license issue message using the Advanced Encryption Standard algorithm and the cryptographic key Ks. The result of decrypting the encrypted usage rights is that the media player software application obtains the usage rights. The media player software application also performs the step 211 of extracting the second block of ciphertext and the session identifier from the license issue message.

The usage rights are basically used by the media player software application to control the use of the digital content. For example, it may restrict the number of times the digital content is played (viewed). Exactly how the usage rules are expressed to control the use of the digital content is outside the scope of this specification, but as persons skilled in the art will appreciate there are well known ways to express usage rights such as XrML, ODRL and OMA.

The media player software application of the computing device 105 is also arranged to perform the step 213 of recording the second block of ciphertext (extracted from the license issue request) for future license renewal requests. When the media player software application wishes to renew the digital content license, it basically follows the previous steps 203 to 207 for the initial license request. However, rather that encrypting the Initialization Vector to obtain the first block of ciphertext, the media player software application encrypts the second block of ciphertext recorded during step 213. The result of encrypting the second block of ciphertext (yet another block of ciphertext) is sent to the license server 103 in a license request message, which is sent via the communication network 7 as an IP packet.

On receiving the subsequent license request message, the digital rights management software application of the license server 103 performs the step 317 of decrypting the received block of ciphertext twice using the Advanced Encryption Standard algorithm and the cryptographic key Ks to obtain encrypted information. The encrypted information is compared to the record of the first block of ciphertext, which the digital rights management software application did when performing the previous step 313. If the subsequent license request from the computing device 105 is valid the encrypted information (obtained during the previous step 317) and the record of the first block of ciphertext will be the same. If the two do not match then the license request will effectively be considered invalid by the digital rights management software application.

If the subsequent license request is considered valid the digital rights management software application will allocate the license using the previous described steps 303 to 315. However, rather than encrypting the first block of ciphertext to obtain the second block of ciphertext (in step 307), the digital rights management software application encrypts (using the Advanced Encryption Standard algorithm and cryptographic key Ks) the block of ciphertext received with the license renewal request from the computing device 105. This encryption process produces a third block of ciphertext, which is sent to the computing device 105 in place of the previously mentioned second block of ciphertext.

On receiving the license renewal, the media player software application of the computing device 105 processes the encrypted information (license renewal) according to the previously described steps 209 to 213. However, rather than keeping a record of the second block of ciphertext for future license renewal requests, a record of the third block of ciphertext is kept for further license renewal requests.

At this point the digital rights management software application of the license server 103 updates (during step 313) the record of the first block of ciphertext such that it corresponds with the third block of ciphertext. The updated record will be used by the digital rights management software application of the license server 103 to check for valid license renewal requests.

If the subsequent license request is considered invalid (that is, the encrypted information and the record of the first block of ciphertext are not the same), the digital rights management software application loaded on the license server 103 will perform the step 319 of determining whether the block of ciphertext received with the license request corresponds to any other blocks of ciphertext that the license server 103 has received in relation to license requests. If it is determined that the block of ciphertext does not correspond with any other blocks of ciphertext, then the digital rights management software application will perform the step 321 of issuing an alert. The alert can be interpreted in a number of ways depending on the application domain of the system 100 and how far back in time the previously received block of ciphertext pertains. For instance, in a content exchanging game scenario such an alert may be interpreted as a previous owner attempting to access a new lease to a content license that has been transferred and recently accessed by the new user/owner. In another scenario, such as in a secure ticketing system, this may be interpreted as a man-in-the-middle security attack, wherein an intermediary attempts to intercept and replicate a request.

It is noted that the method by which the symmetric cryptographic keys Ks are distributed to individual devices may vary between applications. For some applications a single key Ks may be shared across all devices, this making the decryption process uniform between clients, yet making the system more vulnerable to client-side attack. In other applications, higher security can be enforced by individualizing the secret key Ks per device. This method requires an extra set on the transfer of digital content between devices to include the device identifier of the sending device, and storage of all individualized device secrets on the server.

It is noted that the present invention is not concerned with how the computing devices 105 obtain the digital content. However, as person skilled in the art will readily appreciate the digital content could be obtained from the license server 103, or any other computer content server connected to the communications network 107. It is also possible that the digital content could be obtained by taking possession of a computer readable medium such as a CD-ROM on which the digital content is stored.

It will be appreciated by those skilled in the art that whilst the embodiment of the present invention has been described in the context of issuing a license for using digital content, the present invention has application to a range of data that requires a license to make use of the data. For instance, the license may enable a device to make use of a particular software application.

Those skilled in the art will appreciate that the invention described herein is susceptible to variations and modifications other than those specifically described. It should be understood that the invention includes all such variations and modifications which fall within the spirit and scope of the invention.

1. A method for allocating to a device a license to use digital content, the method comprising the steps of:
receiving a first block of ciphertext from the device;
decrypting the first block of ciphertext to obtain a second block of ciphertext;
determining whether the second block of ciphertext meets a criterion; and
allocating the license to the device if the second block of ciphertext meets the criterion.

2. The method as claimed in claim 1, wherein the step of allocating the license comprises the steps of:
encrypting the first block of ciphertext to obtain a third block of ciphertext;
obtaining a usage right for the digital content; and
providing the device with the third block of ciphertext and an encrypted version of the usage right.

3. The method as claimed in claim 1, wherein the step of determining whether the second block of ciphertext meets the criterion comprises the step of determining whether the second block of ciphertext corresponds to a last block of ciphertext received in relation to a request for the license.

4. The method as claimed in claim 3, wherein the step of allocating the license comprises the step of updating the last block of ciphertext such that it corresponds to the first block of ciphertext.

5. The method as claimed in claim 3, further comprising the steps of:
determining whether there exists a previous block of ciphertext that was received in relation to another request for a license and which corresponds to the second block of ciphertext; and
issuing the device with a notification that the license has expired if it is determined that the previous block of ciphertext exists and was obtained prior to the last block of ciphertext being obtained;
wherein the steps of determining whether there exists a previous block, and issuing the device with the notification are carried out upon determining that the second block of ciphertext does not meet the criterion.

6. The method as claimed in claim 1, wherein the license is arranged to expire after a predetermined period of time.

7. A method of requesting a license to use digital content, the method comprising the steps of:
obtaining a first block of ciphertext from a system arranged to allocate the license;
encrypting the first block of ciphertext to obtain a second block of ciphertext; and
providing the second block of ciphertext to the system when requesting the license.

8. The method as claimed in claim 7, further comprising the step of providing the second block of ciphertext to another device for use thereby when requesting the license.

9. A system for allocating a device with a license to use digital content, the system comprising processing means arranged to perform the steps of:
receiving a first block of ciphertext from the device;
decrypting the first block of ciphertext to obtain a second block of ciphertext;
determining whether the second block of ciphertext meets a criterion; and
allocating the license to the device if the second block of ciphertext meets the criterion.

10. The system as claimed in claim 9, wherein the processing means is arranged to perform the following steps when allocating the license to the device:
encrypting the first block of ciphertext to obtain a third block of ciphertext;
obtaining a usage right for the digital content; and
providing the device with the third block of ciphertext and an encrypted version of the usage right.

11. The system as claimed in claim 9, wherein the processing means is arranged to perform the following step when determining whether the second block of ciphertext meets the criterion: determining whether the second block of ciphertext corresponds to a last block of ciphertext received in relation to a request for the license.

12. The system as claimed in claim 11, wherein the processing means is arranged to perform the step of updating the last block of ciphertext such that it corresponds to the first block of ciphertext when allocating the license.

13. The system as claimed in claim 11, wherein the processing means is arranged to perform the following steps:
determining whether there exists a previous block of ciphertext that was received in relation to another request for a license and which corresponds to the second block of ciphertext; and
issuing the device with a notification that the license has expired if it is determined that the previous block of ciphertext exists and was obtained prior to the last block of ciphertext being obtained;
wherein the steps of determining whether there exists a previous block, and issuing the device with the notification are carried out upon determining that the second block of ciphertext does not meet the criterion.

14. The system as claimed in claim 9, wherein the license is arranged to expire after a predetermined period of time.

15. A device for requesting a license to use digital content, the device comprising a processing means arranged to perform the following steps:
obtaining a first block of ciphertext from a system arranged to allocate the license;
encrypting the first block of ciphertext to obtain a second block of ciphertext; and
providing the second block of ciphertext to the system when requesting the license.

16. The device as claimed in claim 15, wherein the processing means is arranged to perform the step of providing the second block of ciphertext to another device for use thereby when requesting the license.

17. A computer program comprising at least one instruction for causing a computing device to carry out the method as claimed in claim 1.

18. A computer readable medium comprising the computer program claimed in claim 17.
